(19) United States
(12) Patent Application Publication
(10) Pub. No.: US 2010/0061351 A1
(43) Pub. Date: Mar. 11, 2010

(54) MULTI-COEXISTENCE COMMUNICATION SYSTEM BASED ON INTERFERENCE-AWARE ENVIRONMENT AND METHOD FOR OPERATING THE SAME

(75) Inventors: Won Cheol LEE, Seoul (KR); Joo Pyoung CHOI, Seoul (KR); Soon Kyu PARK, Seoul (KR); Su Bok LEE, Incheon (KR); Byung Gueon MIN, Seongnam (KR)

Correspondence Address: RABIN & Berdo, PC, 1101 14TH STREET, NW, SUITE 500, WASHINGTON, DC, 20005, US

(73) Assignee: MewTel Technology, Inc., Seoul (KR)

(21) Appl. No.: 12/257,133

(22) Filed: Oct. 23, 2008

(30) Foreign Application Priority Data
Sep. 9, 2008 (KR) 10-2008-0088976

(51) Int. Cl. H04W 72/04; H04B 7/00

(52) U.S. Cl. 370/338; 455/509; 455/501

(57) ABSTRACT

A multi-coexistence communication technology is provided. A multi-coexistence communication system based on an interference-aware environment and a method for operating the same can remove interference detected using an interference temperature limit from at least one transmission signal and transmit the signal to a main/sub communication terminal during data communication on a wired/wireless communication network formed of a main base station, a sub base station, the main communication terminal, and the sub communication terminal, thereby smoothly providing a high-speed seamless data transmission service based on a multi-coexistence communication environment where a distributed small-scale network requiring a low transmission rate, a medium-scale network for providing various wireless communication services, and a large-scale broadcasting network requiring a high transmission rate and high quality coexist, and preventing congestion due to increased demand for frequency resources.

### CROSS-REFERENCE TO RELATED APPLICATION

This application claims the benefit of Korean Patent Application No. 2008-0088976, filed on Sep. 9, 2008, which is hereby incorporated by reference as if fully set forth herein.

### BACKGROUND OF THE INVENTION

1. Field of the Invention

The present invention relates to a multi-coexistence communication technology, and more particularly, to a multi-coexistence communication system based on an interference-aware environment and a method for operating the same that remove interference detected using an interference temperature limit from at least one transmission signal and transmit the signal to a main/sub communication terminal during data communication on a wired/wireless communication network formed of a main base station, a sub base station, the main communication terminal, and the sub communication terminal.

2. Discussion of Related Art

At present, spectrum policies require a coexistence type of high-speed wireless data communication technology capable of efficiently using limited spectrum resources while minimizing frequency deficiency and interference intensification effects due to a problem of exclusively allocating a fixed frequency bandwidth according to a communication service standard and provider.

That is, since demand for various heterogeneous communication services across numerous frequency bands increases, interest in a situation-aware technology for addressing a problem of increased interference between heterogeneous communication services and decreased frequency resources is continuously increasing.

Communication systems proposed for a conventional situation-aware technology are an underlay communication system and an overlay communication system.

The underlay communication system in which a maximum interference boundary level is fixed has a problem in that communication may be impossible when a secondary user transmitter requests radio resources of more than the maximum interference boundary level. The overlay communication system has a problem in that the effect of interference may increase during communication with a secondary user since interference affecting a main user is not considered.

Accordingly, the above-described coexistence communication systems do not dynamically allocate radio resources in consideration of a quantity of interference between users. It is difficult to adopt the above-described coexistence communication systems to efficiently use radio resources since signal transmission for only a secondary user is limited to minimize the effect of interference affecting a main user.

### SUMMARY OF THE INVENTION

The present invention provides a multi-coexistence communication system based on an interference-aware environment and a method for operating the same that can provide an independent interference environment-aware quantification technology for dynamically quantifying interference environment-aware information to efficiently detect an interference environment, an active interference compensation technology for minimizing the effect of interference between users, and an efficient transmission optimization technology for efficiently using limited radio resources.

During data communication on a wired/wireless communication network formed of a main base station, a sub base station, a main communication terminal, and a sub communication terminal, interference detected using an interference temperature limit is removed from at least one transmission signal and the signal is transmitted to the main/sub communication terminal, thereby smoothly providing a high-speed seamless data transmission service based on a multi-coexistence communication environment where a distributed small-scale network requiring a low transmission rate, a medium-scale network for providing various wireless communication services, and a large-scale broadcasting network requiring a high transmission rate and high quality coexist, and preventing congestion due to increased demand for frequency resources.

According to exemplary embodiments of the present invention, a multi-coexistence communication system in which a main base station, a sub base station, a main communication terminal, and a sub communication terminal coexist on a wired/wireless communication network and a main transmission signal generated from the main base station is transmitted to the sub base station, includes: the sub base station that independently generates a sub transmission signal and allocates a frequency bandwidth of the sub communication terminal within a frequency use capacity range after setting frequency use capacity by receiving a preset frequency bandwidth and an interference temperature limit from the main communication terminal; the main communication terminal that receives a true main transmission signal reconfigured by removing a sub transmission signal value determined as an interference factor of the main transmission signal from the sub base station; and the sub communication terminal that receives a true sub transmission signal reconfigured by removing a main transmission signal value determined as an interference factor of the sub transmission signal from the sub base station, wherein the sub base station divides preset transmit power into partial transmit power and remaining transmit power excluding the partial transmit power and simultaneously transmits the true main transmission signal at the partial transmit power and the true sub transmission signal at the remaining transmit power.

According to other exemplary embodiments of the present invention, a method for operating a multi-coexistence communication system in which a main base station, a sub base station, a main communication terminal, and a sub communication terminal coexist on a wired/wireless communication network and a main transmission signal generated from the main base station is transmitted to the sub base station, includes: independently generating, by the sub base station, a sub transmission signal and receiving a preset frequency bandwidth and an interference temperature limit from the main communication terminal; setting, by the sub base station, frequency use capacity using the frequency bandwidth and the interference temperature limit; allocating, by the sub base station, a frequency bandwidth of the sub communication terminal within a frequency use capacity range; dividing, by the sub base station, preset transmit power into partial transmit power and remaining transmit power excluding the partial transmit power; generating, by the sub base station, a true main transmission signal reconfigured by removing a sub transmission signal value determined as an interference factor of the main transmission signal; generating, by the sub base station, a true sub transmission signal reconfigured by removing a main transmission signal value determined as an interference factor of the sub transmission signal; simultaneously transmitting, by the sub base station, the true main transmission signal at the partial transmit power and the true sub transmission signal at the remaining transmit power to external devices; receiving, by the main communication terminal, the true main transmission signal from the sub base station; and receiving, by the sub communication terminal, the true sub transmission signal from the sub base station.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram showing a multi-coexistence communication system based on an interference-aware environment according to an exemplary embodiment of the present invention;

FIG. 2 shows the multi-coexistence communication system based on an interference-aware environment according to an exemplary embodiment of the present invention;

FIG. 3 is a flowchart showing a method for operating the multi-coexistence communication system based on an interference-aware environment according to an exemplary embodiment of the present invention;

FIG. 4 shows an example in which three main base stations using wireless local area network (WLAN), Bluetooth, and Zigbee communication systems are located around a sub base station in a wired/wireless communication network;

FIG. 5 shows a distribution of frequency bandwidths allocated to main/sub base stations in a maximum frequency use capacity range of the sub base station according to an exemplary embodiment of the present invention; and

FIG. 6 is a graph showing a rate of change of frequency use capacity gradually increasing before a frequency use capacity value of the sub base station is reached.

### DETAILED DESCRIPTION OF EXEMPLARY EMBODIMENTS

The invention is described more fully hereinafter with reference to the accompanying drawings, in which exemplary embodiments of the invention are shown.

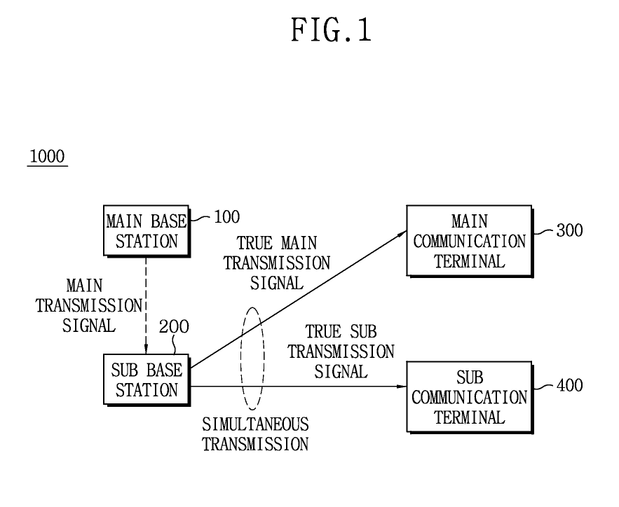

FIG. 1 is a block diagram showing a multi-coexistence communication system based on an interference-aware environment according to an exemplary embodiment of the present invention.

Referring to FIG. 1, a multi-coexistence communication system 1000 includes a main base station 100, a sub base station 200, a main communication terminal 300, and a sub communication terminal 400.

The multi-coexistence communication system 1000 performs a specific signal processing procedure under a Gaussian interference channel or binary symmetric wired/wireless communication channel environment.

First, the sub base station 200 acquires a main transmission signal from the main base station 100 and independently generates a sub transmission signal.

The sub base station 200 separately transmits the main transmission signal to the main communication terminal 300 and the sub transmission signal to the sub communication terminal 400. Before transmission, the main and sub transmission signals are reconfigured by applying a preset interference adaptive coding scheme.

Accordingly, the sub base station 200 generates a true main transmission signal as a result value computed by removing interference from the main transmission signal, and a true sub transmission signal as a result value computed by removing interference from the sub transmission signal.

The sub base station 200 transmits the true main transmission signal from which interference has been removed to the main communication terminal 300 using partial transmit power αPc belonging to a limit range of preset transmit power P.

The sub base station 200 transmits the true sub transmission signal from which interference has been removed to the sub communication terminal 400 using remaining transmit power (1−α)Pc excluding the partial transmit power αPc used to transmit the true main transmission signal.

In other words, the sub base station 200 removes interference by applying the interference adaptive coding scheme to the main and sub transmission signals and separately transmits the true main transmission signal as the result value to the main communication terminal 300 and the true sub transmission signal as the result value to the sub communication terminal 400 in a 1:1 matching form.

Here, the interference adaptive coding scheme generates the true main and sub transmission signals reconfigured by subtracting interference values determined as interference factors before the sub base station 200 externally transmits the main and sub transmission signals.

That is, the interference adaptive coding scheme removes interference by determining in advance an interference value viewed from the main transmission signal as the sub transmission signal and an interference value viewed from the sub transmission signal as the main transmission signal.

In summary, the sub base station 200 generates the true main transmission signal reconfigured by removing the sub transmission signal value as the interference factor from the main transmission signal using the interference adaptive coding scheme and generates the true sub transmission signal reconfigured by removing the main transmission signal value as the interference factor from the sub transmission signal.

The sub base station 200 separately transmits the reconfigured true main transmission signal to the main communication terminal 300 and the reconfigured true sub transmission signal to the sub communication terminal 400 in the 1:1 matching form. In this case, the transmission is performed using a simultaneous transmission scheme.

The simultaneous transmission scheme used in the sub base station 200 is adopted to prevent degradation of multiplexing efficiency due to a problem occurring in an existing time division multiple access (TDMA) or frequency division multiple access (FDMA) system for sequential signal transmission in a time or frequency domain.

Consequently, the main communication terminal 300 and the sub communication terminal 400 respectively receive the true main transmission signal and the true sub transmission signal from which the interference values have been removed from the sub base station 200.

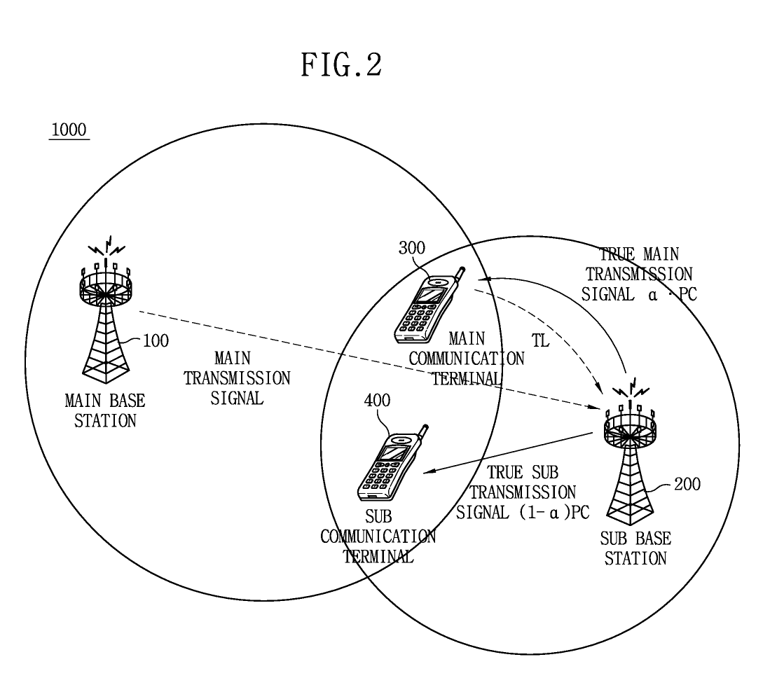

FIG. 2 shows the multi-coexistence communication system based on an interference-aware environment according to an exemplary embodiment of the present invention.

Referring to FIG. 2, the multi-coexistence communication system 1000 based on the interference-aware environment is a communication system for transmitting at least one transmission signal from which an interference value has been removed to the main/sub communication terminal 300/400 by detecting in advance an interference situation during data communication on a wired/wireless communication network formed of the main base station 100, the sub base station 200, the main communication terminal 300, and the sub communication terminal 400.

Before the multi-coexistence communication system 1000 is described in detail with reference to FIG. 2, equations and parameters to be predefined are as follows.

First, an interference temperature limit T_{L} is a value applied to set frequency use capacity C of the sub base station 200 and is computed as shown in Equation 1 using a center frequency fc corresponding to a reference point of the frequency use capacity, a frequency bandwidth B preallocated to the main communication terminal 300, Boltzmann's constant k, and average interference power P_{I}.

$$\begin{matrix}\begin{matrix}{T}_{L} ( {f}_{c} , B ) = \frac{{P}_{I} ( {f}_{c} , B )}{kB} \\ = \frac{1}{kB} ( \frac{1}{B} {\int }_{{f}_{c} - B / 2}^{{f}_{c} + B / 2} S ( f ) d f ) \\ = \frac{1}{{kB}^{2}} {\int }_{{f}_{c} - B / 2}^{{f}_{c} + B / 2} S ( f ) d f\end{matrix} & ( Equation 1 )\end{matrix}$$

In Equation 1, the interference temperature limit T_{L} is computed by dividing an average interference power P_{I} of vectors having the center frequency fc and the frequency bandwidth B, by the product of Boltzmann's constant k and the frequency bandwidth B.

The average power P_{I} is computed by integrating a Power Spectral Density (PSD) S(f) formed in an interval of the frequency bandwidth preallocated to the main communication terminal 300 and dividing the integrated PSD by the bandwidth B.

Second, the frequency use capacity C of the sub base station 200 can be computed using the interference temperature limit T_{L} as shown in Equation 2.

$$C = B {log}_{2} [ 1 + \frac{L ( {T}_{L} ( {f}_{c} , B ) - ( {T}_{I} ( {f}_{c} , B ) )}{{MT}_{I} ( {f}_{c} , B )} ] \qquad ( Equation 2 )$$

Here, L denotes path loss during signal transmission between the sub base station 200 and the sub communication terminal 400, M denotes path loss during signal transmission between the sub base station 200 and the main communication terminal 300, and T_{I}(fc, B) denotes a substantial interference temperature value.

Accordingly, the multi-coexistence communication system 1000 removes interference values present on the wired/wireless communication network based on an operation as described below, and transmits a reconfigured true main transmission signal to the main communication terminal 300 and a reconfigured true sub transmission signal to the sub communication terminal 400.

First, the sub base station 200 receives the main transmission signal from the main base station 100 located on the wired/wireless communication network and receives the preset frequency bandwidth and the interference temperature limit T_{L} from the main communication terminal 300 to independently generate the sub transmission signal.

Before the main transmission signal and the sub transmission signal inputed and stored in the sub base station 200 are transmitted to the main communication terminal 300 and the sub communication terminal 400, the sub base station 200 removes interference from the wired/wireless communication network.

Here, the sub base station 200 should consider the interference temperature limit T_{L} provided from the main communication terminal 300 before an interference removal process.

That is, the sub base station 200 receives the interference temperature limit T_{L}, computed by substituting the center frequency fc corresponding to the reference point of the preset frequency use capacity, the frequency bandwidth B preallocated to the main communication terminal 300, Boltzmann's constant k, and the average interference power P_{I} into Equation 1, from the main communication terminal 300.

The sub base station 200 gradually increases the corresponding bandwidth based on the center frequency fc to its frequency use capacity C, computed by applying the interference temperature limit T_{L} input from the main communication terminal 300 to Equation 2.

As the sub base station 200 increases the frequency use capacity C by a value computed by Equation 2, the frequency bandwidth to be allocated to the sub communication terminal 400 is set within a frequency use capacity range.

In other words, the sub communication terminal 400 is assigned its frequency bandwidth increased by the sub base station 200 in the range of frequency use capacity C.

In Equation 1, it can be seen that the frequency bandwidth B allocated to the main communication terminal 300 is a preset value before the interference temperature limit T_{L} is provided to the sub base station 200.

However, the frequency bandwidth allocated to the sub communication terminal 400 can be detected from only the interference temperature limit T_{L} considering the frequency bandwidth B allocated to the main communication terminal 300 and the frequency use capacity C of the sub base station.

When the main communication terminal 300 in which the frequency bandwidth has been preset provides the interference temperature limit T_{L} to the sub base station 200, the sub communication terminal 400 determines that its frequency bandwidth is set in the range of frequency use capacity C of the sub base station 200.

As described with reference to FIG. 1, the sub base station 200 removes interference from the main and sub transmission signals by applying the preset interference adaptive coding scheme.

The sub base station 200 generates the reconfigured true main and sub transmission signals by removing interference and provides the true main transmission signal to the main communication terminal 300 using the partial transmit power αPc included in the preset limit range of transmit power P.

The sub base station 200 provides the true sub transmission signal to the sub communication terminal 400 using remaining transmit power (1−α)Pc excluding the partial transmit power αPc used to provide the true main transmission signal from the transmit power P.

Here, αPc and (1−α)Pc denote transmit power values used for the true main and sub transmission signals and α denotes a transmit power distribution ratio value.

An operation in which the sub base station 200 transmits the true main transmission signal and the true sub transmission signal as result values computed by removing interference to the main communication terminal 300 and the sub communication terminal 400 will be additionally described.

That is, the sub transmission signal is interference to the main transmission signal and the main transmission signal is interference to the sub transmission signal.

Since the main communication terminal 300 and the sub communication terminal 400 are intended to receive true signal values without interference, the sub base station 200 should provide the true signal values without interference.

The sub base station 200 provides the main communication terminal 300 with the true main transmission signal reconfigured with the true signal value by removing a sub transmission signal component value determined as an interference factor from the main transmission signal received from the main base station 100 using the interference adaptive coding scheme.

The sub base station 200 provides the sub communication terminal 400 with the true sub transmission signal reconfigured with the true signal value by removing a main transmission signal component value determined as an interference factor from the sub transmission signal independently generated using the interference adaptive coding scheme.

Here, the sub base station 200 simultaneously transmits the true main transmission signal and the true main transmission signal reconfigured by removing interference factors to the main communication terminal 300 and the sub communication terminal 400 in a simultaneous transmission scheme.

The simultaneous transmission scheme is an access scheme for preventing degradation of multiplexing efficiency in an existing TDMA or FDMA system for sequential signal transmission in a time or frequency domain.

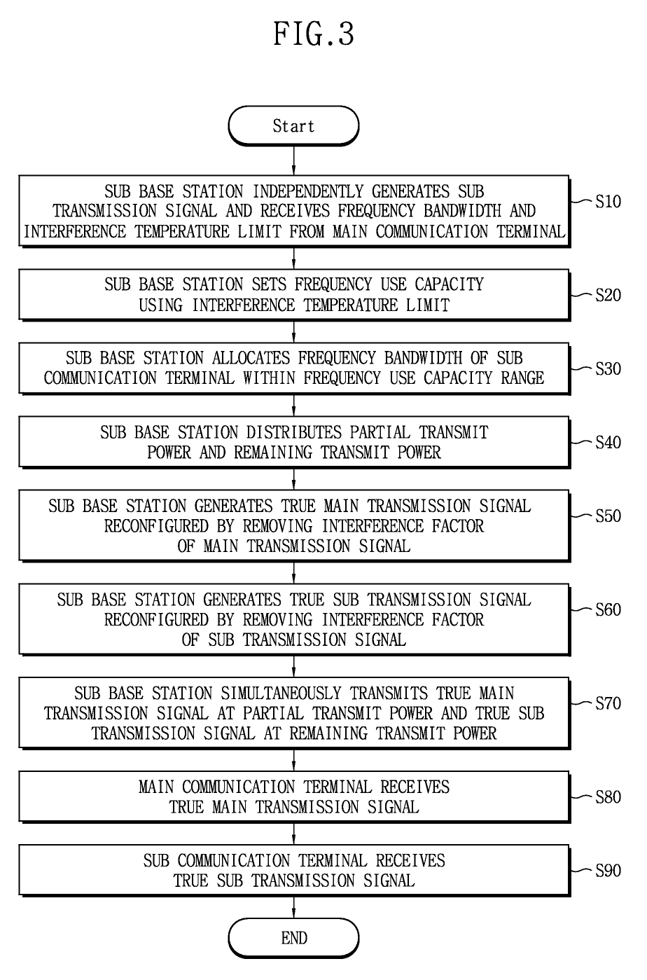

FIG. 3 is a flowchart showing a method for operating the multi-coexistence communication system based on an interference-aware environment according to an exemplary embodiment of the present invention.

Referring to FIG. 3, a method for operating the multi-coexistence communication system transmits at least one transmission signal from which an interference value has been removed to a main/sub communication terminal by detecting an interference situation using an interference temperature limit during data communication on a wired/wireless communication network formed of a main base station, a sub base station, the main communication terminal, and the sub communication terminal.

First, the sub base station acquires a main transmission signal from the main base station, receives an interference temperature limit T_{L} from the main communication terminal, and independently generates a sub transmission signal (S10).

The sub base station sets its frequency use capacity C after gradually increasing frequency bandwidth according to a frequency use capacity value required by the sub communication terminal using the interference temperature limit T_{L} (S20).

The sub base station sets a frequency bandwidth to be allocated to the sub communication terminal in a range of preset frequency use capacity C (S30).

Here, the frequency use capacity C of the sub base station is set by the interference temperature limit T_{L}. In a setting range of frequency use capacity C of the sub base station, a result is produced which does not interfere with the main communication terminal while satisfying the frequency bandwidth required by the sub communication terminal.

The sub base station distributes the preset transmit power P by dividing the preset transmit power P into partial transmit power αPc and remaining transmit power (1−α)Pc from which the partial transmit power has been subtracted (S40).

The sub base station removes interference from the main and sub transmission signals using the preset interference adaptive coding scheme before transmitting the main and sub transmission signals to the main and sub communication terminals.

That is, the sub transmission signal is interference to the main transmission signal and the main transmission signal is interference to the sub transmission signal.

The sub base station generates a true main transmission signal reconfigured by removing a sub transmission signal component value determined as an interference factor from the main transmission signal received from the main base station, and generates a true sub transmission signal reconfigured by removing a main transmission signal component value determined as an interference factor from the independently generated sub transmission signal (S50 and S60).

The sub base station transmits the reconfigured true main transmission signal to the main communication terminal and the reconfigured true sub transmission signal to the sub communication terminal.

At this time, the sub base station separately transmits the true main transmission signal to the main communication terminal using the partial transmit power αPc of the preset transmit power P and the true sub transmission signal to the sub communication terminal using remaining transmit power (1−α)Pc from which the partial transmit power has been subtracted.

When the sub base station transmits the true main transmission signal to the main communication terminal using the partial transmit power αPc and the true sub transmission signal to the sub communication terminal using remaining transmit power (1−α)Pc, it uses the simultaneous transmission scheme for preventing degradation of multiplexing efficiency in the existing TDMA or FDMA system for sequential signal transmission in the time or frequency domain (S70).

Here, the sub base station can be defined as a full-duplex type relay modem or relay hub since the sub base station performs a relay function for transmitting a received signal through signal reception from an outside source, frequency bandwidth allocation, and transmit power division.

Consequently, since a frequency bandwidth of the main communication terminal is preset before the interference temperature limit T_{L} is transmitted to the sub base station, the main communication terminal can sufficiently receive the true main transmission signal within the preset frequency bandwidth (S80).

Since the sub communication terminal is assigned its frequency bandwidth considering the frequency use capacity C preset in the sub base station, the sub communication terminal can sufficiently receive the true sub transmission signal from the sub base station as long as the frequency use capacity is not saturated (S90).

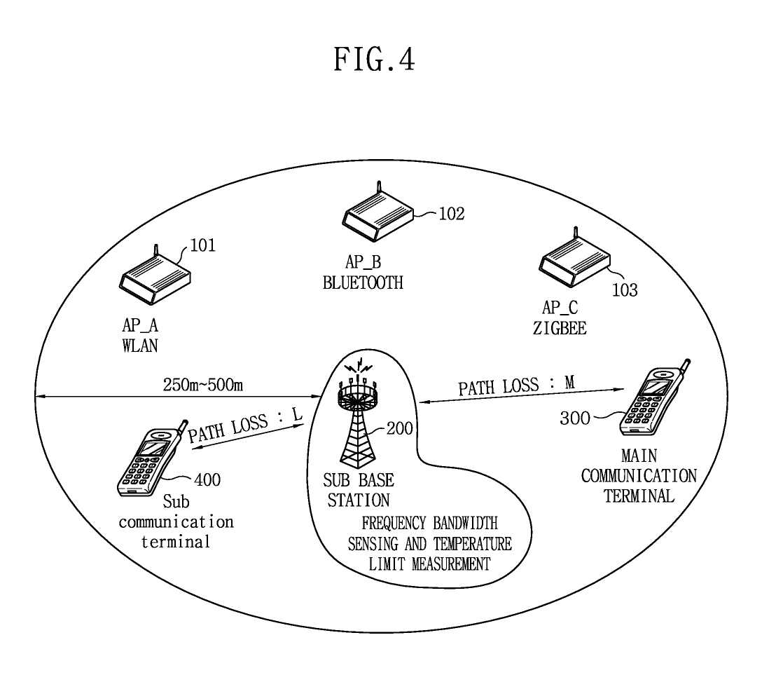

FIG. 4 shows an example in which three main base stations using WLAN, Bluetooth, and Zigbee communication systems are located around a sub base station in a wired/wireless communication network.

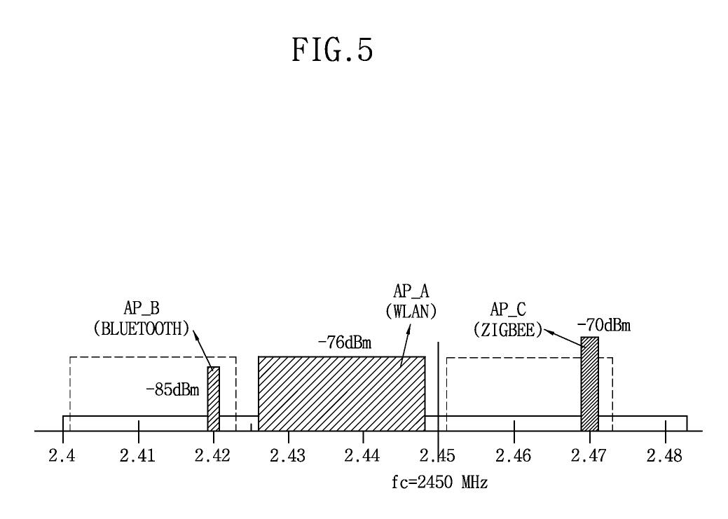

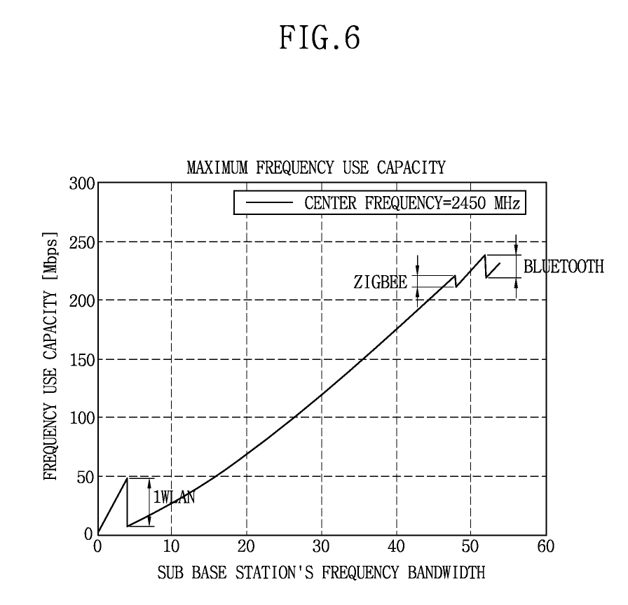

FIG. 5 shows a distribution of frequency bandwidths allocated to main/sub base stations in a maximum frequency use capacity range of the sub base station according to an exemplary embodiment of the present invention, and FIG. 6 is a graph showing a rate of change of frequency use capacity gradually increasing before a frequency use capacity value of the sub base station is reached.

That is, referring to FIG. 4, three main base stations 101, 102, and 103 using communication systems of WLAN AP_A, Bluetooth AP_B, and Zigbee AP_C are located around a sub base station 200 in the wired/wireless communication network.

In this communication environment, one main communication terminal 300 and one sub communication terminal 400 are located in a range of 250 m to 500 m and path loss M is present during signal transmission between one main communication terminal 300 and the sub base station 200.

Path loss L is present during signal transmission between one sub communication terminal 400 and the sub base station 200.

FIG. 5 shows a distribution of frequency bandwidths of the main base stations AP_A, AP_B, and AP_C using the WLAN, Bluetooth, and Zigbee communication systems based on the communication environment of FIG. 4.

For example, it is assumed that center frequencies of the Bluetooth, WLAN, and Zigbee communication systems used in the three main base stations AP_A, AP_B, and AP_C are set to 2424.5 MHz, 2437 MHz, and 2475 MHz.

Transmit powers of −85 dBm, −76 dBm, and −70 dBm defined in the main base stations AP_A, AP_B, and AP_C are minimum power levels required for normal operations thereof. The minimum power levels are applied to compute maximum interference power levels allowed for the main base stations AP_A, AP_B, and AP_C.

In addition to the minimum power level values, signal to noise ratios (SNRs) required by the three main base stations AP_A, AP_B, and AP_C are applied to compute interference power levels allowed for the main base stations AP_A, AP_B, AP_C as shown in Table 1.

In an exemplary embodiment of the present invention, the interference temperature limit is an important data value capable of being acquired based on the computed allowed interference power level.

TABLE 1

| | AP_A | AP_B | AP_C | |
|---|---|---|---|---|
| Parameter | (WLAN) | (Bluetooth) | (Zigbee) | Sub Base station |
| Center | 2437 | 2423.5 | 2475 | 2450 |
| Frequency | | | | |
| (MHz) | | | | |
| Frequency | 22 | 1 | 2 | Variable |
| bandwidth | | | | |
| (MHz) | | | | |
| Transmit power | 14 | 0 | 0 | Variable |
| (dBm) | | | | |
| Required BER | 10⁻⁵ | 10⁻⁵ | 10⁻⁵ | 10⁻⁵ |
| Required SNR | 8.4 | 2 | 2.5 | 7.56 |
| (dB) | | | | |

Distance between devices

| | |
|---|---|
| Distance between main communication terminal and sub | 15 m |
| base station | |
| Distance between main base station and sub base | 6 m |
| station | |
| Distances between main base station and sub | AP_A: 400 m |
| communication terminal | AP_B: 300 m |
| | AP_C: 500 m |
| Distance between main base station and main | AP_A: 300 m |
| communication terminal | AP_B: 80 m |
| | AP_C: 120 m |

In Table 1, the parameters predefined by simulation represent the center frequencies, the transmit powers, and the distances between devices for the main base stations AP_A, AP_B, and AP_C based on the communication environment of FIG. 4.

The interference power levels allowed for the main base stations AP_A, AP_B, and AP_C are computed by dividing the minimum power levels required for normal operations of the main base stations AP_A, AP_B, and AP_C by the SNRs required by the main base stations AP_A, AP_B, and AP_C.

Here, the interference temperature limit is a value computed by dividing the interference power levels allowed for the main base stations AP_A, AP_B, and AP_C by the product of Boltzmann's constant and a total frequency bandwidth allocated to the sub base station.

As shown in FIG. 5, the sub base station performs a process for gradually increasing its frequency bandwidth while maintaining the same interval on left and right sides with respect to the center frequency of 2450 MHz.

In FIG. 6 showing a graph of a change rate of frequency use capacity gradually increasing before a frequency use capacity value of the sub base station is reached, it can be seen that the frequency bandwidth of the sub base station gradually increases by the same amount on the left and right sides of the center frequency of 2450 MHz.

For example, when a bandwidth increment is 4 MHz, that is, when a total increment of 4 MHz includes an increment of 2 MHz on the left side and an increment of 2 MHz on the right side of the center frequency of 2450 MHz, the frequency band of the sub base station first overlaps with that formed in the main base station AP_A (using WLAN). Accordingly, the frequency use capacity of the sub base station is rapidly decreased as indicated by a first breaking lower-limit curve on the graph of FIG. 6.

When the frequency bandwidth of the sub base station is continuously increased, the frequency use capacity of the sub base station is gradually increased while exiting a first capacity decrease point of the main base station AP_A.

When a process for increasing the frequency bandwidth of the sub base station is continuously performed, the frequency use capacity of the sub base station is continuously increased.

In this case, when the frequency band of the main base station AP_C (using Zigbee) present at a second adjacent position overlaps with that of the sub base station as shown in FIG. 5, the frequency use capacity of the sub base station is decreased once more as shown in the lower-limit curve.

Like when the frequency bands of the main base stations AP_A and AP_C overlap with that of the sub base station, the frequency use capacity of the sub base station is decreased to a lower limit when the frequency band of the main base station AP_B (using Bluetooth) present at a third adjacent position overlaps with that of the sub base station.

In the case of Zigbee, when a frequency bandwidth increment of the sub base station reaches a total of 48 MHz formed by an increment of 24 MHz on the left side and an increment of 24 MHz on the right side of the center frequency of 2450 MHz, the frequency use capacity of the sub base station is decreased.

In the case of Bluetooth, when a frequency bandwidth increment of the sub base station reaches a total of 52 MHz formed by an increment of 26 MHz on the left side and an increment of 26 MHz on the right side of the center frequency of 2450 MHz, the frequency use capacity of the sub base station is decreased.

Table 2 shows parameters of the sub base station computed using the graph of FIG. 6.

TABLE 2

| Parameter | Optimum Value |
|---|---|
| Center Frequency | 2450 MHz |
| Frequency bandwidth | 16.5 MHz |
| Transmit power | AP_A (WLAN): −20.75 dBm |
| | AP_B (Bluetooth): −8.75 dBm |
| | AP_C (Zigbee): −23.44 dBm |

When the center frequency of the sub base station is set to 2450 MHz, it can be seen that the frequency bandwidth required to achieve the frequency use capacity (52 Mbps) required by the sub communication terminal is 16.5 MHz.

In other words, in the graph of FIG. 6, a value of 16.5 MHz on the horizontal axis corresponds to a value of 52 Mbps on the vertical axis.

As shown in Table 2, when the sub base station transmits a signal at its corresponding transmit power, the sub base station does not interfere with the main base station.

A multi-coexistence communication system based on an interference-aware environment and a method for operating the same can remove interference detected using an interference temperature limit from at least one transmission signal and transmit the signal to a main/sub communication terminal during data communication on a wired/wireless communication network formed of a main base station, a sub base station, the main communication terminal, and the sub communication terminal, thereby smoothly providing a high-speed seamless data transmission service based on a multi-coexistence communication environment where a distributed small-scale network requiring a low transmission rate, a medium-scale network for providing various wireless communication services, and a large-scale broadcasting network requiring a high transmission rate and high quality coexist, and preventing congestion due to increased demand for frequency resources.

While exemplary embodiments of the present invention have been described above, it will be apparent to those skilled in the art that various changes and modifications can be made to the described exemplary embodiments without departing from the spirit or scope of the invention defined by the appended claims and their equivalents.

What is claimed is:

1. A multi-coexistence communication system comprising:
a main base station generating a main transmission signal;
a sub base station receiving the main transmission signal from the main base station;
a main communication terminal; and
a sub communication terminal, wherein:
the main base station, the sub base station, the main communication terminal and the sub communication terminal coexist on a wired/wireless communication network;
the sub base station independently generates a sub transmission signal and allocates a frequency bandwidth of the sub communication terminal within a frequency use capacity range after setting frequency use capacity by receiving a preset frequency bandwidth and an interference temperature limit from the main communication terminal;
the main communication terminal receives a true main transmission signal reconfigured by removing a sub transmission signal value determined as an interference factor of the main transmission signal from the sub base station;
the sub communication terminal receives a true sub transmission signal reconfigured by removing a main transmission signal value determined as an interference factor of the sub transmission signal from the sub base station; and
the sub base station divides preset transmit power into partial transmit power and remaining transmit power excluding the partial transmit power and simultaneously transmits the true main transmission signal at the partial transmit power and the true sub transmission signal at the remaining transmit power.

2. The multi-coexistence communication system of claim 1, wherein the interference temperature limit is computed by computing a center frequency corresponding to a reference point of the frequency use capacity, a frequency bandwidth preallocated by the main communication terminal, Boltzmann's constant, and average interference power, integrating a power spectral density formed in an interval of the frequency bandwidth preallocated by the main communication terminal, and dividing the integrated power spectral density by the frequency bandwidth.

3. The multi-coexistence communication system of claim 1, wherein the frequency use capacity is computed by computing the interference temperature limit, path loss during data communication between the main base station and at least one of the main communication terminal and the sub communication terminal, path loss during data communication between the sub base station and the main communication terminal, and a substantial interference temperature value.

4. The multi-coexistence communication system of claim 1, wherein a rate of change of the frequency use capacity is decreased when the main communication terminal uses the true main transmission signal with the preallocated frequency bandwidth and the change rate of the frequency use capacity is gradually increased before a frequency use capacity value is reached when the true main transmission signal is not in use.

5. The multi-coexistence communication system of claim 1, wherein when the sub base station transmits the true main transmission signal to the main communication terminal and the true sub transmission signal to the sub communication terminal, the sub base station performs simultaneous transmission by adopting a simultaneous transmission scheme having higher multiplexing efficiency than at least one of time division multiple access (TDMA) and frequency division multiple access (FDMA).

6. A method for operating a multi-coexistence communication system in which a main base station, a sub base station, a main communication terminal, and a sub communication terminal coexist on a wired/wireless communication network and a main transmission signal generated from the main base station is transmitted to the sub base station, the method comprising:
independently generating, by the sub base station, a sub transmission signal and receiving a preset frequency bandwidth and an interference temperature limit from the main communication terminal;
setting, by the sub base station, frequency use capacity using the frequency bandwidth and the interference temperature limit;
allocating, by the sub base station, a frequency bandwidth of the sub communication terminal within a frequency use capacity range;
dividing, by the sub base station, preset transmit power into partial transmit power and remaining transmit power excluding the partial transmit power;
generating, by the sub base station, a true main transmission signal reconfigured by removing a sub transmission signal value determined as an interference factor of the main transmission signal;
generating, by the sub base station, a true sub transmission signal reconfigured by removing a main transmission signal value determined as an interference factor of the sub transmission signal;
simultaneously transmitting, by the sub base station, the true main transmission signal at the partial transmit power and the true sub transmission signal at the remaining transmit power to external devices;
receiving, by the main communication terminal, the true main transmission signal from the sub base station; and
receiving, by the sub communication terminal, the true sub transmission signal from the sub base station.

7. The method of claim 6, further comprising:
computing, by the sub base station, an interference temperature limit T_{L} by using an equation
$${T}_{L} ( {f}_{c} , B ) = \frac{{P}_{I} ( {f}_{c} , B )}{kB} ,$$
wherein fc is a center frequency corresponding to a reference point of the frequency use capacity, B is a frequency bandwidth preallocated to the main communication terminal, K is Boltzmann's constant k, and P_{I} is an average interference power, and
wherein the average interface power P_{I} is calculated by integrating a power spectral density formed in an interval of the frequency bandwidth B and dividing the integrated power spectral density by the frequency bandwidth B.

8. The method of claim 6, further comprising:
extracting, by the sub base station, parameter values of an interference temperature limit T_{L}, a path loss L during data communication between the main base station and at least one of the main communication terminal and the sub communication terminal, a path loss M during data communication between the sub base station and the main communication terminal, and a substantial interference temperature value T_{I}; and
computing, by the sub base station, frequency use capacity C by substituting the extracted parameter values T_{L}, L, M, and T_{I} into
$$C = B {log}_{2} [ 1 + \frac{L ( {T}_{L} ( {f}_{c} , B ) - ( {T}_{L} ( {f}_{c} , B ) )}{{MT}_{I} ( {f}_{c} , B )} ] .$$

9. The method of claim 6, further comprising:
decreasing a rate of change of the frequency use capacity when the main communication terminal uses the true main transmission signal with the preallocated frequency bandwidth; and
gradually increasing the change rate of the frequency use capacity before a frequency use capacity value is reached when the true main transmission signal is not in use.

10. The method of claim 6, further comprising:
performing simultaneous transmission by adopting a simultaneous transmission scheme having higher multiplexing efficiency than at least one of TDMA and FDMA when the sub base station transmits the true main transmission signal to the main communication terminal and the true sub transmission signal to the sub communication terminal.
